(19) United States
(12) Patent Application Publication
(10) Pub. No.: US 2024/0293953 A1
(43) Pub. Date: Sep. 5, 2024

(54) Transparent Stain Matching Device

(71) Applicant: Color Communications, LLC, Chicago, IL (US)

(72) Inventor: Jerald Dimas, West Chicago, IL (US)

(21) Appl. No.: 18/178,361

(22) Filed: Mar. 3, 2023

(51) Int. Cl. B27K 5/02; B32B 7/06; B32B 7/12; B32B 27/36; C09D 15/00

(52) U.S. Cl. CPC B27K 5/02; B32B 7/06; B32B 7/12; B32B 27/36; C09D 15/00; B32B 2307/402; B32B 2307/412

(57) ABSTRACT

A transparent color sample stain matching device for comparing the appearance that coating or stain would have on a base material to previously coated or stained portions of the base material and a method for generating a transparent color sample stain matching device is described. The stain matching device includes a clear substrate sheet, a pressure sensitive adhesive, and a transparent coating. The transparent coating may include a base liquid and a color additive. The stain matching device is configured such that optical properties of the stain matching device applied to an uncoated portion of the base material are within a predetermined range of similarity of optical properties of a coated portion of the base material. In this way, the transparent color sample stain matching device applied to uncoated portions of the base material produces the general appearance of coated portions of the base material.

### BACKGROUND OF THE INVENTION

The present invention relates generally to the field of color sample display devices. The present invention relates specifically to a transparent color sample device applicable to a base material to preview the general appearance of the base material if a specific coating or stain were applied to the base material.

### SUMMARY OF THE INVENTION

One embodiment of the invention relates to a transparent color sample for facilitating the selection of a liquid stain having a color. The stain is applicable to an unstained base material having a type such that, after the stain is applied to the base material, the stained material reflects light which can be sampled by a light monitoring instrument to generate a first value representative of color.

The transparent color sample includes a clear substrate sheet having a first side and a second side. A pressure sensitive adhesive is applied to the first side of the clear substrate sheet, and a transparent coating is applied to the second side of the clear substrate sheet. The transparent coating includes a base liquid and a color additive. The color additive is correlated to material of the type of the base material as stained with the stain having the color such that, when the transparent color sample covers at least a portion of the surface of the unstained base material, the combination of the color sample and the covered portion of the surface of the unstained base material reflects light which causes the light monitoring instrument to generate a second value. The second value is within a range of ten percent above or below the first value.

Another embodiment of the invention relates to a transparent color sample for facilitating the selection of a liquid stain having a stain color. The stain is applicable to a type of wood such that, after the stain is applied to the wood, the stained wood reflects light having a first color.

The transparent color sample includes a polyester sheet having a first side and a second side. A pressure sensitive adhesive is applied to the first side of the polyester sheet, and a removable adhesive coversheet is applied to the pressure sensitive adhesive. A transparent coating is applied to the second side of the polyester sheet. The transparent coating includes a base liquid and a color additive. The color additive is correlated to the type of wood after being stained with the stain having the stain color such that, when the transparent color sample covers at least a portion of the surface of the wood, the combination of the color sample and the covered portion of the surface of the unstained wood reflects light having a second color. The second color is within a CIE76 color difference formula Delta E of 2 of the first color.

Another embodiment of the invention relates to a method for generating a transparent color sample. The method includes selecting a stain having a color. The method includes applying the stain to a type of wood. The method includes allowing the stain to dry to produce a stained wood sample. The method includes monitoring light reflected by the stained wood sample to generate a first value. The method includes applying a transparent color coating having a composition to an adhesive backed transparent sheet to produce a color sample sheet. The method includes placing the color sample sheet on an unstained piece of wood of the type to cover a portion of the wood. The method includes monitoring the light reflected by the covered portion of the wood to generate a second value. The method includes comparing the first value to the second value to determine if the second value is within a predetermined range of the first value.

Additional features and advantages will be set forth in the detailed description which follows, and, in part, will be readily apparent to those skilled in the art from the description or recognized by practicing the embodiments as described in the written description and claims thereof, as well as the appended drawings. It is to be understood that both the foregoing general description and the following detailed description are exemplary.

The accompanying drawings are included to provide further understanding and are incorporated in and constitute part of the specification. The drawings illustrate one or more embodiments, and together with the description serve to explain the principles and operation of various embodiments.

Alternative exemplary embodiments relate to other features and combinations of features as may be generally recited in the claims.

### BRIEF DESCRIPTION OF THE DRAWINGS

This application will become more fully understood from the following detailed description, taken in conjunction with the accompanying figures, wherein like reference numerals refer to like elements in which:

FIG. 1 is an exploded perspective view of layers of a transparent color sample applied to a base material, according to an exemplary embodiment.

FIG. 2 is a side view of layers of a transparent color sample, according to an exemplary embodiment.

FIG. 3 is a top view of a transparent color sample applied to an unstained portion of a base material adjacent to a stained portion of the base material, according to an exemplary embodiment.

FIG. 4 is a side view of a light monitoring device measuring the properties of light reflected off of a stained portion of a base material and a light monitoring device measuring the properties of light reflected off of an unstained portion of the base material to which a transparent color sample has been applied, according to an exemplary embodiment.

### DETAILED DESCRIPTION

Referring generally to the figures, various embodiments of a transparent color sample stain matching device are shown. Embodiments of the color sample discussed herein include an innovative layer composition designed to provide for a variety of desired characteristics, including transparency, adhesion to various surfaces, and color matching to pre-coated samples of base material when applied to uncoated portions of the base material. Traditionally, color matching transparent coatings on base materials, such as stain on wood, to precoated portions of the base material requires applying coating to uncoated samples of the base material, allowing the coating to dry, and comparing the precoated portions to the newly coated portions to determine if the color produced by the base material and the coating is within an acceptable range of the color of the precoated portions. Traditional opaque color sample devices are inadequate for color matching transparent coatings applied to base materials in many instances because the combination of the properties of the coatings and the properties of the base materials dictate the color and appearance of the coated base material. Applicant has found it beneficial to provide a transparent or semi-transparent color sample device configured to match the color and appearance of a base material having a transparent or semi-transparent coating when applied to an uncoated portion of the base material. This allows users to compare the precoated base material with the uncoated base material as it would appear after the coating associated with the color sample is applied, without having to apply the coating to a test portion of the base material.

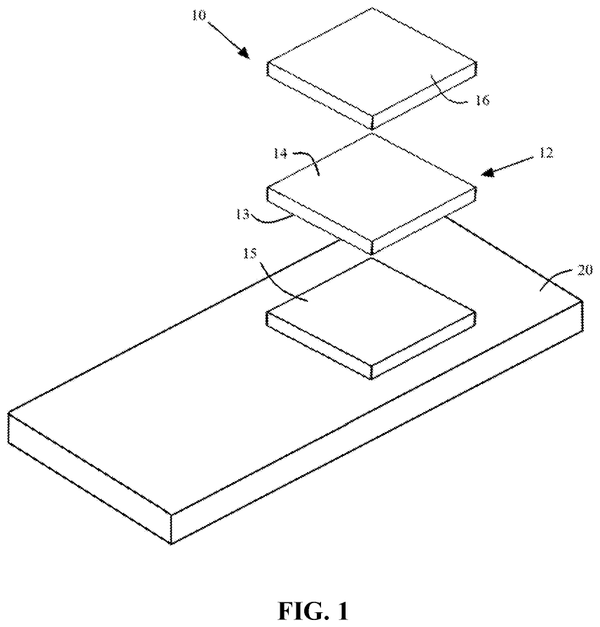

Referring to FIG. 1, an exploded perspective view of a color sample 10 applied to a base material 20 is shown according to an exemplary embodiment. Color sample 10 includes a transparent substrate sheet 12. The substrate sheet 12 has a first side 13 and a second side 14. The color sample 10 includes an adhesive layer 15 that is applied to the first side 13 of the substrate sheet 12. The color sample 10 includes a transparent coating 16. The transparent coating 16 is applied to the second side 14 of the substrate sheet 12. In an alternative embodiment, the transparent coating 16 is applied to the first side of the transparent substrate sheet 12 such that the transparent coating 16 is between the adhesive layer 15 and the substrate sheet 12.

The combination of the adhesive layer 15, substrate sheet 12, and transparent coating 16 results in a transparent or semi-transparent color sample 10, such that light can transmit through the color sample 10, reflect off of the base material 20, and transmit out of the color sample 10. The color sample 10 is transparent if the color sample 10 transmits 70 percent or more of light projected onto the color sample 10 at an angle of incidence that is perpendicular to the second side of the substrate sheet 12 or if the American Society for Testing and Materials (“ASTM”) D1746 Standard Test Method for Transparency of Plastic Sheeting transparency value for the color sample 10 is 70 or greater. According to some embodiments, the color sample 10 transmits 30 percent or more of light incident on the color sample 10 perpendicular to the second side of the substrate sheet 12 or has an ASTM D1746 transparency value of 30 or greater. In another embodiment, the color sample 10 transmits 50 percent or more of light incident on the color sample 10 perpendicular to the second side of the substrate sheet 12 or has an ASTM D1746 transparency value of 50 or greater. In a specific embodiment, the color sample 10 transmits 80 percent or more of light incident on the color sample 10 perpendicular to the second side of the substrate sheet 12 or has an ASTM D1746 transparency value of 80 or greater.

As shown in FIG. 1, the adhesive layer 15 of the color sample 10 can be applied to the base material 20 to adhere the color sample 10 to the base material 20. In some embodiments, the base material 20 includes a type of wood. For example, the base material 20 can include oak wood, cherry wood, poplar wood, pine wood, birch wood, or walnut wood. The base material 20 can include a type of metal. For example, the base material 20 can include aluminum, copper, or steel. In a specific embodiment, the base material 20 includes composite materials. In another specific embodiment, the base material 20 includes plastics.

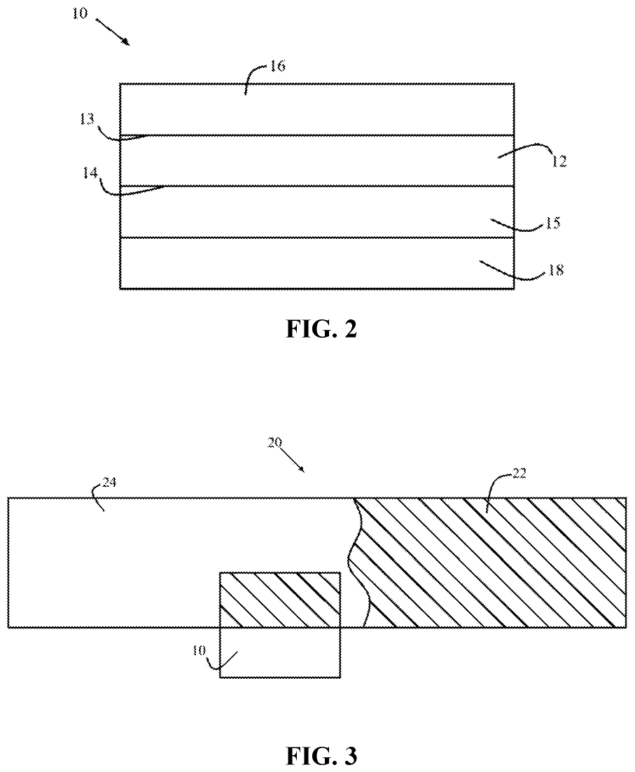

Referring to FIG. 2, a side view of a color sample 10 is shown according to an exemplary embodiment. As shown in FIG. 2, the color sample 10 includes a release liner 18. The release liner 18 is applied to the opposite side of the adhesive layer 15 from the first side 13 of the substrate sheet 12. The release liner 18 protects the adhesive layer 15 during storage and transport of the color sample 10. The release liner 18 can be removed prior to applying the color sample 10 to a base material 20. The release liner 18 can be a removable adhesive coversheet. In a specific embodiment, the release liner 18 is a printable release liner having a basis weight of 96 #or 96 pounds per ream or 500 sheets.

The substrate sheet 12 can be formed from clear polyester. The thickness of the substrate sheet 12 is in the range of about 1.0 mil to about 4.0 mils (one mil is 0.001 inch). In a specific embodiment, the thickness of the substrate sheet 12 is between 1.5 and 2.5 mils.

The adhesive layer 15 allows users to adhere the color sample 10 to the surface of a base material 20 regardless of the orientation of the surface of the base material 20. The adhesive layer 15 can include a pressure sensitive adhesive. The adhesive layer 15 can be a solvent-based pressure sensitive adhesive. In a specific embodiment, the adhesive layer 15 provides the color sample 10 with an adhesive peel strength between 0.20 and 0.50 pounds per inch when tested in accordance with the ASTM D3330 standard test method for peel adhesion.

The transparent coating 16 includes a base liquid and a color additive. In a specific embodiment, the base liquid is a clear nitrocellulose-based lacquer. In an alternative embodiment, the base liquid is water based. The color additive includes micronized pigments and/or metal complex dyes. The color additive changes the properties of the color sample 10 with respect to light reflection, transmission, and absorption.

The transparent coating 16 has a dried thickness in the range of about 0.5 mil to 1.5 mil. In a specific embodiment, the transparent coating 16 has a dried thickness in the range of 0.8 mil to 1.2 mil. The transparent coating 16 can include a flattening agent. The flattening agent reduces the glossy and reflective properties of the surface of the transparent coating 16 and can be included in the transparent coating 16 to replicate the glossy or reflective properties of the precoated portions 22 of the base material 20.

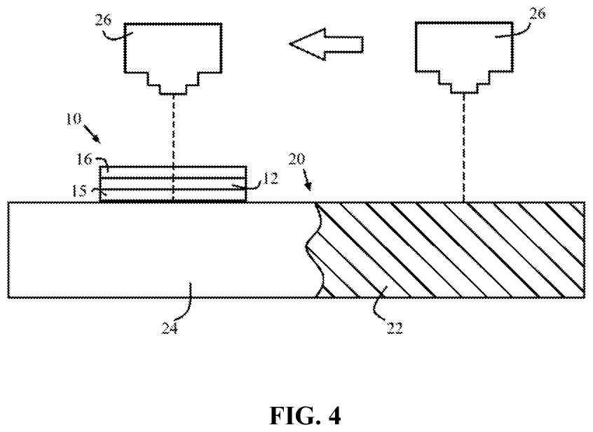

Referring to FIGS. 3 and 4, a color sample 10 is shown applied to an uncoated portion 24 of a base material 20 adjacent to a precoated portion 22 of the base material 20, according to an exemplary embodiment. The composition of the color sample 10 is configured such that the combination of the color sample 10 and the uncoated portion 24 of the base material 20 has optical properties with respect to color and light reflection that are within a predetermined acceptable range of similarity to the precoated portion 22 of the base material 20. The coating applied to the precoated portion 22 can be a liquid stain having a color. In a specific embodiment, the uncoated portion 24 is coated with a stain having a different color than a stain applied to the precoated portion 22. The degree of transparency of the color sample 10 generally corresponds to the degree of transparency of the coating applied to the base material 20 to generate the precoated portion 22.

As shown in FIG. 4, a light monitoring instrument 26 monitors the light reflected off of the uncoated portion 24 and the precoated portion 22 to determine the optical properties of the color sample 10 applied to the uncoated portion 24 of the base material 20 and of the precoated portion 22 of the base material 20, according to an exemplary embodiment. The light monitoring instrument 26 is used to measure or calculate the color or wavelength and/or the intensity of the light reflected off of the respective portions of the base material 20. In a specific embodiment, the light monitoring instrument 26 includes a spectrophotometer. The light monitoring instrument 26 can include a charge-coupled device or a camera.

The light monitoring instrument 26 is used to generate a value corresponding to optical properties, such as color and/or reflectivity, after monitoring the light reflected off of the color sample 10 applied to the uncoated portion 24 of the base material 20 and of the precoated portion 22 of the base material 20. The color sample 10 and uncoated portion 24 are exposed to generally the same conditions of light (i.e., light having intensity, wavelength, coherence, and angle of incidence each within ±10%) as the precoated portion 22 when the light is monitored. In a specific embodiment, a spectrometer measures the brightness and color of the color sample 10 and uncoated portion 24 and of the precoated portion 22.

Referring to FIG. 4, a precoated portion 22 of the base material 20 is generated by first selecting a coating. The coating is applied to the base material 20. The coating is allowed to dry on the base material 20. The light that reflects off of the precoated portion 22 can then be monitored to generate a first value corresponding to its optical properties with respect to color and/or reflectivity. The light reflected off of the precoated portion 22 can be monitored by the light monitoring instrument 26 to generate the first value correlating to optical properties of the precoated portion 22. In a specific embodiment, the base material 20 is a type of wood and the coating is a stain having a color, such that the precoated portion 22 of the base material 20 is a stained wood sample.

A color sample 10 is generated by applying the transparent coating 16 to a transparent substrate sheet 12 including an adhesive layer 15. The color sample 10 is applied to an uncoated portion 24 of the base material 20 such that the color sample covers a portion of the uncoated portion 24. The light that reflects off of the uncoated portion 24 and through the color sample 10 can then be monitored to generate a second value corresponding to the optical properties with respect to color and/or reflectivity of the combination of the color sample 10 and the uncoated portion 24. The light reflected off of the uncoated portion 24 and through the color sample 10 can be monitored by the light monitoring instrument 26 to generate the second value correlating to optical properties of the combination of the color sample 10 and the uncoated portion 24. A flattening agent can be included in the transparent coating 16 prior to applying the color sample 10 to the uncoated portion 24. In a specific embodiment, the transparent coating 16 is dried prior to applying the color sample 10 to the uncoated portion 24.

The first value corresponding to the optical properties of the precoated portion 22 is compared with the second value corresponding to the optical properties of the combination of the color sample 10 and the uncoated portion 24 to determine if those respective optical properties are within a predetermined acceptable range of similarity. The first and second values can correspond to color, such as RGB triplets or CMYK values. The first and second values can correspond to brightness, reflectivity, and/or lightness. In a specific embodiment, the first and second values correspond to CIELAB coordinates. CIELAB coordinates include a lightness value, L*, measured on a scale from 0-100, wherein 0 represents black and 100 represents white, a green-red value, a*, wherein negative values indicate green color and positive values indicate red color, and a blue-yellow value, b*, wherein negative values indicate blue color and positive values indicate yellow color. The comparison of the first value and the second value can include determining the ΔE (“Delta E”) value between the precoated portion 22 and the combination of the color sample 10 and the uncoated portion 24. The ΔE value is defined by the following equation, commonly referred to as the CIE76 color difference formula:

$$Δ E = \sqrt{{( {L}_{2}^{*} - {L}_{1}^{*} )}^{2} + {( {a}_{2}^{*} - {a}_{1}^{*} )}^{2} + {( {b}_{2}^{*} - {b}_{1}^{*} )}^{2}}$$

wherein (L₁^{*}, a₁^{*}, b₂^{*}) is the first value and represents the CIELAB coordinates representing the color of the precoated portion 22 and (L₂^{*}, a₂^{*}, b₂^{*}) is the second value and represents the CIELAB coordinates representing the color of the combination of the color sample 10 and the uncoated portion 24.

In a specific embodiment, the predetermined acceptable range of similarity between the precoated portion 22 and the combination of the color sample 10 and the uncoated portion 24 is defined by the comparison of the first and second values producing a ΔE value that is less than or equal to 2. Alternatively, the predetermined acceptable range of similarity between the precoated portion 22 and the combination of the color sample 10 and the uncoated portion 24 can be defined by the comparison of the first and second values producing a ΔE value that is less than or equal to 15. In another embodiment, the predetermined acceptable range of similarity between the precoated portion 22 and the combination of the color sample 10 and the uncoated portion 24 is defined by the comparison of the first and second values producing a ΔE value that is less than or equal to 10.

Alternatively, the comparison of the first and second values can include calculating a percentage difference of the second value with respect to the first value. In a specific embodiment, the comparison of the first and second values includes calculating a percentage difference of a component of the second value with respect to the corresponding component of the first value. The acceptable range of similarity between the first value and the second value is a percentage difference of less than or equal to 10%. Alternatively, the acceptable range of similarity between the first value and the second value can be defined as a percentage difference of less than or equal to 5%. The acceptable range of similarity between the first value and the second value can be defined as a percentage difference of less than or equal to 2%. In a specific embodiment, the acceptable range of similarity between the first value and the second value is a percentage difference of less than or equal to 1%.

According to an exemplary embodiment, the optical properties of the color sample 10 can be modified if the second value falls outside of the acceptable range after comparing the first value to the second value. In order to modify the optical properties of the color sample 10, a different composition of the color additive of the transparent coating 16 is included in the color sample 10. The composition of the pigments, dyes, and/or flattening agents included in the color additive can be selected to match the color and reflective characteristics of a precoated portion 22 of the base material 20 when the color sample 10 is applied to an uncoated portion 24 of the base material 20. For example, if the light reflected off of the precoated portion 22 is significantly more red than the light reflected off of the combination of the color sample 10 and uncoated portion 24, then the composition of the transparent coating 16 can be modified by including a higher concentration of red micronized pigments or metal complex dyes in the color additive.

The color sample 10 is placed on the uncoated portion 24 again after the composition of the transparent coating 16 is modified. The light reflected off of the uncoated portion 24 and through the color sample 10 is monitored, and the second value corresponding to the optical characteristics of the combination of the color sample 10 and the uncoated portion 24 of the base material 20 is regenerated. Then the regenerated second value is compared to the first value to determine if the second value is within the acceptable range of similarity of the first value. In a specific embodiment, if the regenerated second value is not within the acceptable range of similarity of the first value, the method of modifying the composition of the transparent coating 16 of the color sample 10, reapplying the color sample 10 to the uncoated portion 24, monitoring the light reflecting therefrom to regenerate the second value, and comparing the second value to the first value is repeated until the second value is within the acceptable range of similarity of the first value.

Values related to the thickness of the substrate sheet 12, adhesive layer 15, and/or transparent coating 16 can be stored in a database along with the second value corresponding to the optical properties of the combination of the color sample 10 and the uncoated portion 24. Values related to the type and concentration of micronized pigments, metal complex dyes, and/or flattening agents included in the transparent coating 16 can be stored in a database along with the second value corresponding to the optical properties of the combination of the color sample 10 and the uncoated portion 24. The first value corresponding to the optical properties of the precoated portion 22 can be generated, and then the first value can be compared with the values stored in the database to determine the appropriate thickness of the substrate sheet 12, adhesive layer 15, and/or transparent coating 16 of the color sample 10 and/or the appropriate type and concentration of micronized pigments, metal complex dyes, and/or flattening agents that would produce a color sample 10 such that the light monitoring instrument 26 would generate a second value when monitoring the light reflected off of an uncoated portion 24 of the base material 20 at least partially covered by the color sample 10 that is within the acceptable range of similarity of the first value. The appropriate thicknesses of the substrate sheet 12, adhesive layer 15, and/or transparent coating 16 of the color sample 10 and/or the appropriate types and concentrations of micronized pigments, metal complex dyes, and/or flattening agents can be determined by interpolating the values stored in the database that correspond to two or more previous second values that are closest to the first value.

It should be understood that the figures illustrate the exemplary embodiments in detail, and it should be understood that the present application is not limited to the details or methodology set forth in the description or illustrated in the figures. It should also be understood that the terminology is for the purpose of description only and should not be regarded as limiting.

Further modifications and alternative embodiments of various aspects of the invention will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present invention.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more component or element, and is not intended to be construed as meaning only one.

While the current application recites particular combinations of features in the claims appended hereto, various embodiments of the invention relate to any combination of any of the features described herein whether or not such combination is currently claimed, and any such combination of features may be claimed in this or future applications. Any of the features. elements, or components of any of the exemplary embodiments discussed above may be used alone or in combination with any of the features, elements, or components of any of the other embodiments discussed above.

What is claimed is:

1. A transparent color sample for facilitating selection of a liquid stain having a color, the stain being applicable to an unstained base material having a type, wherein after application of the stain, the stained base material reflects light which can be sampled by a light monitoring instrument to generate a first value representative of color, the transparent color sample comprising:
a clear substrate sheet having a first side and a second side;
a pressure sensitive adhesive applied to the first side; and
a transparent coating applied to the second side, the coating comprising:
a base liquid; and
a color additive being correlated to material of the type as stained with the stain having the color such that when the transparent color sample covers at least a portion of a surface of the unstained base material, the combination of the color sample and the covered portion of the surface of the unstained base material reflects light which causes the light monitoring instrument to generate a second value within a range of ten percent above or below the first value.

2. The sample of claim 1, wherein the unstained base material comprises material selected from the group of material types consisting of: woods such as oak, cherry, poplar, pine, birch or walnut; metals such as aluminum, copper or steel; composite materials; and plastics.

3. The sample of claim 1, wherein the color additive comprises micronized pigments.

4. The sample of claim 1, wherein the color additive comprises metal complex dyes.

5. The sample of claim 1, wherein the base liquid is a clear nitrocellulose based lacquer.

6. The sample of claim 1, wherein the clear substrate sheet is polyester and has a thickness of between 1.5 and 2.5 mils.

7. The sample of claim 1, wherein the pressure sensitive adhesive is a solvent-based pressure sensitive adhesive.

8. The sample of claim 1, further comprising a printable release liner which is adhered to the pressure sensitive adhesive and removable prior to applying the color sample to the surface of the unstained base material.

9. The sample of claim 1, wherein the unstained base material is a material which has been stained, but not stained by the stain having the color.

10. The sample of claim 1, wherein the coating includes a flattening agent.

11. A transparent color sample for facilitating the selection of a liquid stain having a stain color, the stain being applicable to a type of wood, wherein after application of the stain, the stained wood reflects light having a first color, the transparent color sample comprising:
a polyester sheet having a first side and a second side;
a pressure sensitive adhesive applied to the first side;
a removable adhesive coversheet applied to the pressure sensitive adhesive; and
a transparent coating applied to the second side, the coating comprising:
a base liquid; and
a color additive being correlated to the type of wood after being stained with the stain having the stain color such that when the transparent color sample covers at least a portion of a surface of the wood that is unstained, the combination of the color sample and the covered portion of the surface of the unstained wood reflects light having a second color within a CIE76 color difference formula Delta E of 2 of the first color.

12. The sample of claim 11, wherein the wood is selected from the group consisting of oak, cherry, poplar, pine, birch or walnut.

13. The sample of claim 11, wherein the coating includes micronized pigments and metal complex dyes.

14. The sample of claim 13, wherein the base liquid is a clear nitrocellulose based lacquer, and the coating includes a flattening agent.

15. The sample of claim 13, wherein the base liquid is a clear nitrocellulose based lacquer, the coating has a thickness between 0.8 mils and 1.2 mils, and the polyester sheet has a thickness of between 1.5 mils and 2.5 mils.

16. A method for generating a transparent color sample comprising:
selecting a stain having a color;
applying the stain to a type of wood;
allowing the stain to dry to produce a stained wood sample;
monitoring light reflected by the stained wood sample to generate a first value;
applying a transparent color coating having a composition to an adhesive backed transparent sheet to produce a color sample sheet;
placing the color sample sheet on an unstained piece of wood of the type to cover a portion of the wood;
monitoring the light reflected by the covered portion of the wood to generate a second value; and
comparing the first value to the second value to determine if the second value is within a predetermined range of the first value.

17. The method of claim 16, wherein the composition of the color coating is modified when the second value is outside of the predetermined range of the first value; and
wherein, after the composition of the color coating is modified, the color sample sheet is again placed on the unstained piece of wood, the light reflected by the covered portion of the wood is monitored to regenerate the second value, and the first value is compared to the second value to determine if the second value is within the predetermined range of the first value.

18. The method of claim 17, wherein the method of claim 17 is repeated until the second value is within the predetermined range of the first value.

19. The method of claim 16, further comprising applying a flattening agent to the color coating.

20. The method of claim 19, further comprising drying the color coating prior to placing the transparent color sample on the unstained wood.

21. The method of claim 16, wherein the predetermined range is defined such that the second value is within the predetermined range of the first value if the light reflected by the covered portion of the wood is a color within a CIE76 color difference formula Delta E of 2 of a color of the light reflected by the stained wood sample; and
wherein the monitoring of the light reflected by the stained wood sample and the light reflected by the covered portion of the wood includes monitoring via a spectrophotometer.
